(19) United States
(12) Patent Application Publication
(10) Pub. No.: US 2017/0046795 A1
(43) Pub. Date: Feb. 16, 2017

(54) SYSTEMS, COMPUTER-IMPLEMENTED METHODS, AND COMPUTER-READABLE MEDIA FOR GENERATING A TOPICAL MEDIA STREAM

(71) Applicant: GStream Holdings, LLC, Greenwood, ME (US)

(72) Inventor: Barclay Layman, Auburn, ME (US)

(21) Appl. No.: 15/208,739

(22) Filed: Jul. 13, 2016

Related U.S. Application Data
(60) Provisional application No. 62/205,343, filed on Aug. 14, 2015.

(51) Int. Cl. G06Q 50/00; G06F 21/62; G06F 17/30

(52) U.S. Cl. CPC G06Q 50/01; G06F 17/30516; G06F 17/30887; G06F 17/30864; G06F 21/6245

(57) ABSTRACT

One aspect of the invention provides a computer-implemented method of generating a topical media stream. The method includes: polling a plurality of Internet-accessible media sources for new publicly available content; storing the new publicly available content in a database along with metadata describing the content; selecting a subset of publicly available content stored in the database that is relevant to a topic; combining the selected subset with private content to form a topical media stream; and publishing the stream via the Internet.

### CROSS-REFERENCE TO RELATED APPLICATION

This application claims priority under 35 U.S.C. § 119(e) to U.S. Provisional Patent Application Ser. No. 62/205,343, filed Aug. 14, 2015. The entire content of this application is hereby incorporated by reference herein.

### BACKGROUND OF THE INVENTION

Businesses and other entities seek to engage with customers, patrons, employees, and other people. Existing technologies are expensive and/or cumbersome to implement.

### SUMMARY OF THE INVENTION

One aspect of the invention provides a computer-implemented method of generating a topical media stream. The method includes: polling a plurality of Internet-accessible media sources for new publicly available content; storing the new publicly available content in a database along with metadata describing the content; selecting a subset of publicly available content stored in the database that is relevant to a topic; combining the selected subset with private content to form a topical media stream; and publishing the stream via the Internet.

This aspect of the invention can have a variety of embodiments. The polling step can include requesting all new publicly available content available since a last polling request. The polling step can include specifying one or more search terms relevant to the topical media stream. The polling step can specify one or more selected from the group consisting of: a minimum and/or maximum taken date or upload date for photographs, location information, content filtering levels, and licensing status.

The database can include a copy of the new content. The database can include a Uniform Resource Locator (URL) specifying a location of the new content. The database can include one or more tags describing the new content.

The private content can include one or more selected from the group consisting of: a logo, an advertisement, and marketing collateral.

The computer-implemented method can further include: receiving inventory information; and modifying the stream based on the inventory information.

The computer-implemented method can further include: receiving viewer information about potential viewers in proximity to a display device; and modifying the stream based on the inventory information. The viewer information can be derived from a one or more cameras. The viewer information can be derived one or more selected from the group consisting of: a social network, a search and discovery network, and a mobile payments platform.

The computer-implemented method can further include: receiving location information about the display device; and modifying the stream based on the location information.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a system for generating a topical media stream according to an embodiment of the invention.

FIG. 2 depicts a system for generating a topical media stream according to an embodiment of the invention.

FIG. 3 depicts a method for generating a topical media stream according to an embodiment of the invention.

### DEFINITIONS

The instant invention is most clearly understood with reference to the following definitions.

As used herein, the singular form “a,” “an,” and “the” include plural references unless the context clearly dictates otherwise.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

### Systems for Generating a Topical Media Stream

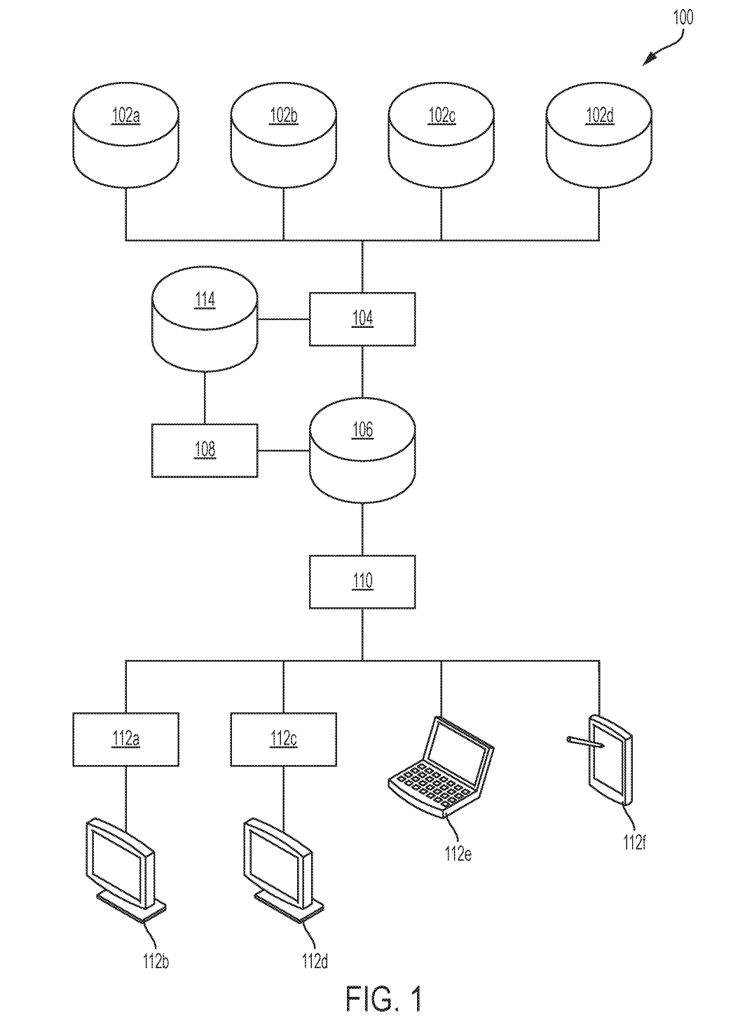

Referring now to FIG. 1, one aspect of the invention provides a system 100 for generating a topical media stream.

The system 100 can communicate with a variety of Internet-accessible media sources 102 to access variety of content. For example, digital media from a variety of existing assets (e.g., local and external content and relevant social media from the Internet) can be repurposed.

Exemplary content includes static slides bearing text and/or images (e.g., MICROSOFT® POWERPOINT® (PPT), MICROSOFT® WORD™, PDF, and similar formats), formatted text (e.g., HTML, XML, MICROSOFT® WORD™, and similar formats), images (e.g., JPEG, TIFF, GIF, BMP, PNG, and other formats), audio (e.g., MP3, AAC, FLAC, and similar formats), video (e.g., MPEG, APPLE® QUICKTIME®, .mp4, 4K video, and similar formats), and the like.

Exemplary media sources include image and video hosting services (e.g., FACEBOOK®, FLICKR®, INSTRAGRAM®, IMGUR®, METACAFE®, MYSPACE®, PINTEREST®, SHUTTERFLY®, SNAPFISH®, VIMEO®, YOUTUBE®, and the like), social media sites (e.g., FACEBOOK®, LINKEDIN®, MYSPACE®, PINTEREST®, TWITTER®, and the like), file storage and synchronization services (e.g., DROPBOX®, GOOGLE® DRIVE™, and the like), weblogs, and the like.

An acquisition server 104 can periodically obtain new content from media sources 102. For example, the acquisition server 104 can periodically (e.g., every 15 seconds, every minute, every hour, and the like) poll one or more media sources 102 for new content. Alternatively, the media sources 102 can periodically push new content acquisition server 104.

Requests can be made via various application programming interfaces (APIs) published by media sources 102 to allow access to content. APIs can specify the formats of various requests and responses.

The requests and/or pushes can relate to or include all new content available since a last transaction or can be focused on content meeting certain criteria. For example, acquisition server 104 can maintain a list of search terms relevant to current media streams. For example, if the system 100 is producing a stream related to basketball, the acquisition server 104 can conduct periodic searches for content related to basketball, the National Basketball Association (NBA), the Boston Celtics, LeBron James, and the like.

The requests can additionally or alternatively specify other search terms. For example, the search term can specify a minimum and/or maximum taken date or upload date for photographs, location information, content filtering (safe search) levels, licensing status, and the like. For example, the flickr.photos.search method allows the passing of a license argument to restrict the search results to images and videos made available under one or more CREATIVE COMMONS® licenses.

The obtained content can be stored in a database 106. Database 106 can be operated through a database management system (DBMS). A DBMS is imposed upon the data to form a logical and structured organization of the data. A DBMS lies between the physical storage of data and the users and handles the interaction between the two. Examples of DBMSes include DB2® and INFORMIX®, both available from IBM Corp. of Armonk, N.Y.; MICROSOFT EXCEL®, MICROSOFT JET®, and MICROSOFT SQL SERVER®, all available from the Microsoft Corp. of Redmond, Wash.; MYSQL®, available from the MySQL Ltd. Co. of Stockholm, Sweden; ORACLE® Database, available from Oracle Intl Corp. of Redwood City, Calif.; and SYBASE®, available from Sybase, Inc. of Dublin, Calif.; POSTGRESQL™ available from The PostgreSQL Global Development Group.

Database 106 can include copies of the actual content obtained or can include links to the obtained content. For example, database can include a Uniform Resource Locator (URL) specifying a location of the obtained content.

Database 106 can also obtain other information regarding the obtained content including James guarding Dwight Howard can be associated in the database 106 with tags such as “basketball”, “NBA”, “Cleveland”, “Cavaliers”, “Houston”, “Rockets”, and the like.

A curation server 108 can be utilized to review captured content and indicate whether any or all of the captured content is relevant and/or appropriate for a particular stream. For example, a human can review the captured content and select whether one or more items of content should be added to a particular stream. The content can be stored and accessed through an interface, where it can be displayed as a stream along with other streams (such as broadcasts). The content can be stored for future use and can be added to other streams (e.g., location-based streams), e.g., through a drag-and-drop GUI. This addition can occur in real-time without the need for manipulation of any device displaying the stream.

Content acquisition server 104 and/or curation server 108 can also acquire private content from one or more private data sources 114. Such private content can be included within a stream along with publicly-available content obtained from sources 102. For example, a customer may want to interleave their logo(s), advertisement(s), and/or other marketing collateral with topical publicly-available data. This would allow a concert hall to generate a stream that includes both private content such as a logo and advertisements for upcoming shows and public content such as photos taken at the concert hall and posted by patrons on the FLICKR® service for display before a concert. Various advertisers can also pay for placement of advertisements within the stream.

A stream server 110 can host one or more streams for display on a plurality of devices 112. For example, a plurality of content items can be incorporated into a stream. In one embodiment, the stream is presented as a ROKU® channel, e.g., using the BrightScript programming language and documentation provider in the ROKU® Developer Guide (http://sdkdocs.roku.com/display/sdkdoc/Developer+Guide#DeveloperGuide-12Developingwitht heRokuSDK) and other documentation provided by Roku, Inc. of Saratoga, Calif. and others. The “channel” can be a public channel that is listed in the ROKU® Channel Store and general viewable by any user or can be a private channel that is only accessible through entry of a code. The stream can be provided using a variety of standards such as the Hypertext Transfer Protocol (HTTP) and Extensible Markup Language (XML)-based technologies like Media Rich Site Summary (MRSS), RESTful Application Programming Interfaces (APIs), and JavaScript Object Notation (JSON). Video can be provided in a variety of formats including the H.264 video coding format with Advanced Audio Coding—Low Complexity (AAC-LC) audio wrapped in a MP4 container. The ROKU® platform also supports the VC-1 video codec and the WMA and MP3 audio codecs.

The stream provided by stream server 110 can be accessed by one or display devices 112 for display to an end user. The display devices 112 can be a commercially available, off-the-shelf (COTS) device provided or purchased by an end user or can be provided as part of a subscription. Exemplary display devices 112 include ROKU® streaming players 112a, 112c, available from Roku, Inc. of Saratoga, Calif. that include a central processing unit (CPU), memory, network connections (e.g., through IEEE 802.11 (WI-FI) transmitters and/or Category 5/5e ETHERNET™ ports), and one or more audio/video ports (e.g., HDMI® or composite). Such a ROKU® streaming player can be controlled by a user to access the channel, download content from the channel, and display the channel on a display device such as televisions or monitors 112b, 112d. Other exemplary display devices include computers 112e (e.g., personal computers, laptop computers, desktop computers, and the like), handheld devices 112f (e.g., smartphones, tablets, and the like), smartwatches, wearable computing devices, and the like. Such display devices 112 can be placed in retail, commercial, business, recreational, and other settings to provide relevant content to customers, employees, visitors, and the like. For example, the stream can be displayed in a retail store to provide general information, in proximity to a product, at a point-of sale location, and the like.

Any of components 102, 104, 106, 108, 110, 114 can be local machines or can be provided as a cloud-based service managed by a third party. For example, databases 106, 114 can be implemented through a storage-as-a-service solution offered “through the cloud” such as the AMAZON EC2® elastic repository service. Likewise stream server 110 can be implemented through a content delivery network or content distribution network (CDN) provided by Akamai Technologies of Cambridge, Massachusetts, Amazon.com, Inc. of Seattle, Wash., telecommunications service providers (TSP), and the like.

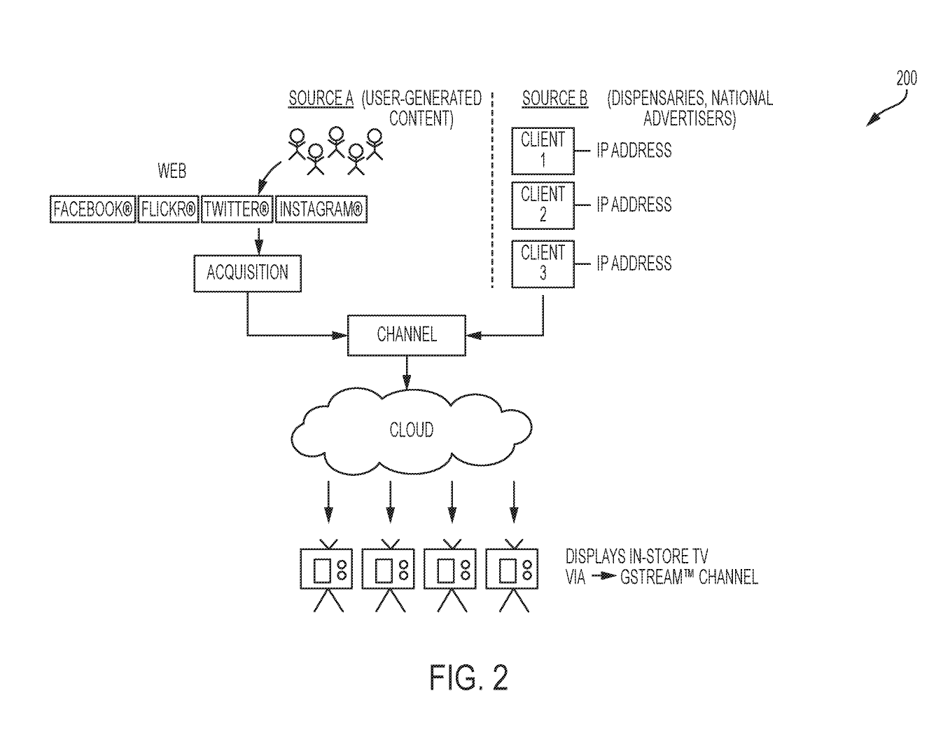

FIG. 2 depicts another embodiment of a system 200 for generating a topical media stream.

### Real-Time Modification of Topical Streams

The topical streams described herein can be modified in real-time either by a human or by machine. For example, systems 100, 200 can be communicate with inventory management software to modify the stream to reflect inventory. For example, systems 100, 200 can modify a stream for a particular store to remove or deemphasize products that are out of stock, emphasize products that are selling slowly, emphasize products that are in high demand at particular time periods, and the like.

In still another embodiment, systems 100, 200 can tailor a stream to reflect the customers within viewing distance of the screen. For example, display devices 112 can include one or more cameras capable of classifying one or more individuals in front of the camera as being of a certain gender and/or age range. Additionally or alternatively, customers can provide or emit various identifying information via an electronic device. For example, consumers may choose to “check-in” at a store using the FACEBOOK® or FOURSQUARE® services, pay for goods or services using the LEVELUP® or SQUARE® services, and the like. In any case, systems 100, 200 can receive information of varying granularity and specificity regarding a potential audience of a stream and modify the stream based on that information. Such modifications can be based on human-generated or data-mined rules.

In still another embodiment, the stream can be modified to reflect the location of the device. For example, a location can be associated with a particular display device, e.g., during registration of the customer to access a private channel. Additionally or alternatively, information regarding the location can be inferred based on the IP address of the device 112 accessing the stream or by one or more cookies stored on the device 112. This enables the marketing and sale of a cohesive channel to a single user or class of users while still permitting variations in the content by providing a separate private version of the channel to each display device.

### Methods for Generating a Topical Media Stream

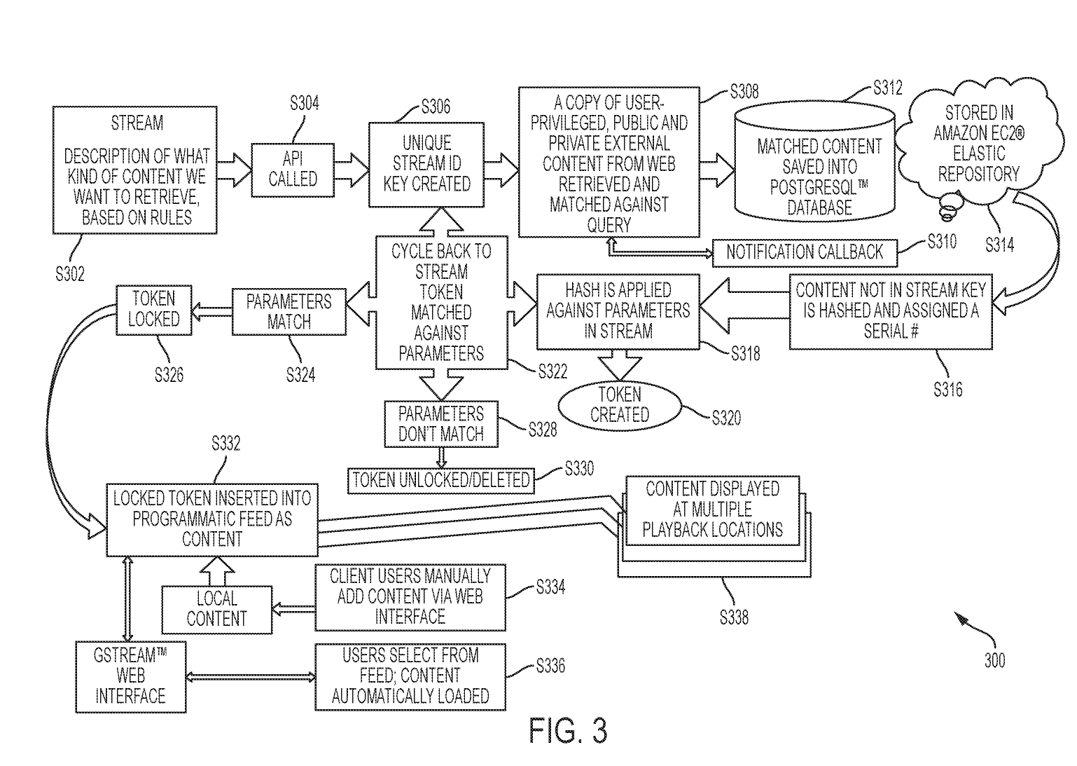

Referring now to FIG. 3, another aspect of the invention provides a method 300 for generating a topical stream.

In step S302, the stream is defined based on a plurality of rules. The stream can be broadly defined (e.g., a stream related to dogs) or can be narrowly defined (e.g., a stream including information for a pet store located in ZIP code 02116). Streams can also be defined at varying levels of granularity. For example, the term “stream” can be used to define a class of (e.g., a national chain of pet stores) while local content can be added to an individual stream provided separately to each local pet store.

In step S304, an API call is made to one or more content sources (e.g., FACEBOOK®, FLICKR®, INSTRAGRAM®, TWITTER®, and the like) for publicly available content relevant to the stream. All or a broad class of content can be obtained or targeted queries can be executed based one or more search terms. For example, the flickr.photos.search method can be utilized to search for publicly available photographs tagged with the words “dog” “puppy”, and the like. The API call can be performed once, a plurality of times, and/or on a periodic basis.

After or while the API call is executed, a unique stream ID key can be created in step S306. This unique stream ID key can be utilized for storing the content received in response to the API call(s) in step S304.

In step S308, content is received from one or more sources. If search terms were not applied to the original request, the search terms can be applied to the received content.

In step S310, a notification callback can be made to the content source indicating what content was obtained.

In steps S312 and S314, the matched content can be saved in a database and/or a cloud-based storage service.

In step S316, content that is not in a stream key can be hashed and assigned a serial number. The hashing process can encode information about the content including the content type, its source, and the like.

In step S318, this hash is applied against parameters in a stream. For example, the hash may indicate that the content is in a non-preferred format and trigger reformatting of the content into a preferred format (e.g., PNG for images or MP4 for video). One or more rows referencing the content can also be added to various database tables.

In step S320, a token can be created. The token can be a binary value indicating whether the content will be stored and used in a stream or deleted. This step can be made in response to a curator's input.

In step S322, the selection of content for inclusion in a stream can be compared against the original criteria for the outgoing feed. The curator can be alerted to inconsistencies or extraneous tags and can confirm whether the content should be included in the outgoing feed or whether the content should be rejected based on the inconsistency. For example, if the stream criteria searched for “large dogs” and the user elected to include an image that was tagged as containing both a “large dog” and a “small dog”, the curator can be alerted to this potential inconsistency and choose whether to retain the image in the outgoing feed in steps S324 and S326 or remove the content from the feed in steps S328 and S330.

In step S332, the locked token is inserted into the outgoing programmatic feedback as content.

In step S334, a client can manually add local content (e.g., advertisements, announcements, and the like) to the stream via a web interface.

Likewise, in step S336, a client can select particular content from the stream for display at their location. For example, the client may want to display a particular image or advertisement instead of cycling through the content in the feed.

In step S338, the content of the outgoing stream is displayed at one or more playback locations. The client can also manipulate the stream using controls on the local display device (e.g., using a remote control associated with a ROKU® streaming player),Implementation in

Computer-Readable Media and/or Hardware

The methods described herein can be readily implemented in software that can be stored in computer-readable media for execution by a computer processor. For example, the computer-readable media can be volatile memory (e.g., random access memory and the like) and/or non-volatile memory (e.g., read-only memory, hard disks, floppy disks, magnetic tape, optical discs, paper tape, and the like).

Additionally or alternatively, the methods described herein can be implemented in computer hardware such as an application-specific integrated circuit (ASIC).

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method of generating a topical media stream, the method comprising:
polling a plurality of Internet-accessible media sources for new publicly available content;
storing the new publicly available content in a database along with metadata describing the content;
selecting a subset of publicly available content stored in the database that is relevant to a topic;
combining the selected subset with private content to form a topical media stream; and
publishing the stream via the Internet.

2. The computer-implemented method of claim 1, wherein the polling step includes requesting all new publicly available content available since a last polling request.

3. The computer-implemented method of claim 1, wherein the polling step includes specifying one or more search terms relevant to the topical media stream.

4. The computer-implemented method of claim 1, wherein the polling step specifies one or more selected from the group consisting of: a minimum and/or maximum taken date or upload date for photographs, location information, content filtering levels, and licensing status.

5. The computer-implemented method of claim 1, wherein the database includes a copy of the new content.

6. The computer-implemented method of claim 1, wherein the database includes a Uniform Resource Locator (URL) specifying a location of the new content.

7. The computer-implemented method of claim 1, wherein the database includes one or more tags describing the new content.

8. The computer-implemented method of claim 1, wherein the private content includes one or more selected from the group consisting of: a logo, an advertisement, and marketing collateral.

9. The computer-implemented method of claim 1, further comprising:
receiving inventory information; and
modifying the stream based on the inventory information.

10. The computer-implemented method of claim 1, further comprising:
receiving viewer information about potential viewers in proximity to a display device; and
modifying the stream based on the inventory information.

11. The computer-implemented method of claim 10, wherein the viewer information is derived from a one or more cameras.

12. The computer-implemented method of claim 10, wherein the viewer information is derived one or more selected from the group consisting of: a social network, a search and discovery network, and a mobile payments platform.

13. The computer-implemented method of claim 1, further comprising:
receiving location information about the display device; and
modifying the stream based on the location information.
